(19) United States
(12) Patent Application Publication
(10) Pub. No.: US 2005/0245244 A1
(43) Pub. Date: Nov. 3, 2005

(54) System and method for placing an inbound wireless call in context and wireless communication device incorporating the same

(75) Inventors: Leonardo W. Estevez, Rowlett, TX (US); Carl M. Panasik, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/837,995

(22) Filed: May 3, 2004

(51) Int. Cl. H04M 3/42

(52) U.S. Cl. 455/415; 455/412.1

(57) ABSTRACT

A system for, and method of, placing an inbound wireless call in context and a wireless communication device incorporating the system or the method. In one embodiment, the system includes: (1) a calling party identifier resident within a wireless communication device and configured to make an identification of a calling party associated with the inbound wireless call and (2) a user data retriever resident within the wireless communication device and configured to respond to the identification by retrieving user data associated with the calling party from a database and displaying the user data on a display of the wireless communication device.

### TECHNICAL FIELD OF THE INVENTION

The present invention is directed, in general, to wireless telecommunications and, more specifically, to a system and method for placing an inbound wireless call in context and a wireless communication device incorporating the system or the method.

### BACKGROUND OF THE INVENTION

Wireless communication devices such as wireless telephones have become virtually indispensable in today's world. At one time, such devices were limited to placing and receiving telephone calls. Now, however, such devices are provided with powerful processors, large memories and displays and well thought-out graphical user interfaces, which allow them to execute sophisticated applications and provide a host of valuable functions to a user in addition to simply acting as a telephone. So-called “road warriors” rely on their wireless communication devices to provide them vital information while they are traveling, and their customers are now beginning to expect their service not to suffer just because the road warriors are in airport terminals instead of their offices.

Despite their sophistication, wireless communication devices are still receptive to significant improvement. Accordingly, what is needed in the art is a way to make more relevant data available to the user of a wireless communication device. What is further needed in the art is a way to prepare the user more thoroughly for the wireless telephone calls he must handle.

### SUMMARY OF THE INVENTION

To address the above-discussed deficiencies of the prior art, the present invention provides, in one aspect, a system for placing an inbound wireless call in context. In one embodiment, the system includes: (1) a calling party identifier resident within a wireless communication device and configured to make an identification of a calling party associated with the inbound wireless call and (2) a user data retriever resident within the wireless communication device and configured to respond to the identification by retrieving user data associated with the calling party from a database and displaying the user data on a display of the wireless communication device.

In another aspect, the present invention provides a method of placing an inbound wireless call in context. In one embodiment, the method includes: (1) making an identification of a calling party associated with the inbound wireless call with a calling party identifier resident within a wireless communication device, (2) responding to the identification by retrieving user data associated with the calling party from a database with a user data retriever resident within the wireless communication device and (3) displaying the user data on a display of the wireless communication device.

In another aspect, the present invention provides a wireless communication device. In one embodiment, the wireless communication device includes: (1) a body, (2) a keypad coupled to the body, (3) a display coupled to the body and the keypad and (4) a processor located within the body, coupled to the keypad and the display and containing a system for placing an inbound wireless call in context. In one embodiment, the system includes: (4a) a calling party identifier that makes an identification of a calling party associated with the inbound wireless call and (4b) a user data retriever that responds to the identification by retrieving user data associated with the calling party from a database and displaying the user data on the display.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of a wireless infrastructure containing one embodiment of a wireless communication device that includes a system for placing an inbound wireless call in context constructed according to the principles of the present invention;

FIG. 2 illustrates a more detailed block diagram of one embodiment of a system for placing an inbound wireless call in context constructed according to the principles of the present invention; and

FIG. 3 illustrates a flow diagram of one embodiment of a method of placing an inbound wireless call in context carried out according to the principles of the present invention.

### DETAILED DESCRIPTION

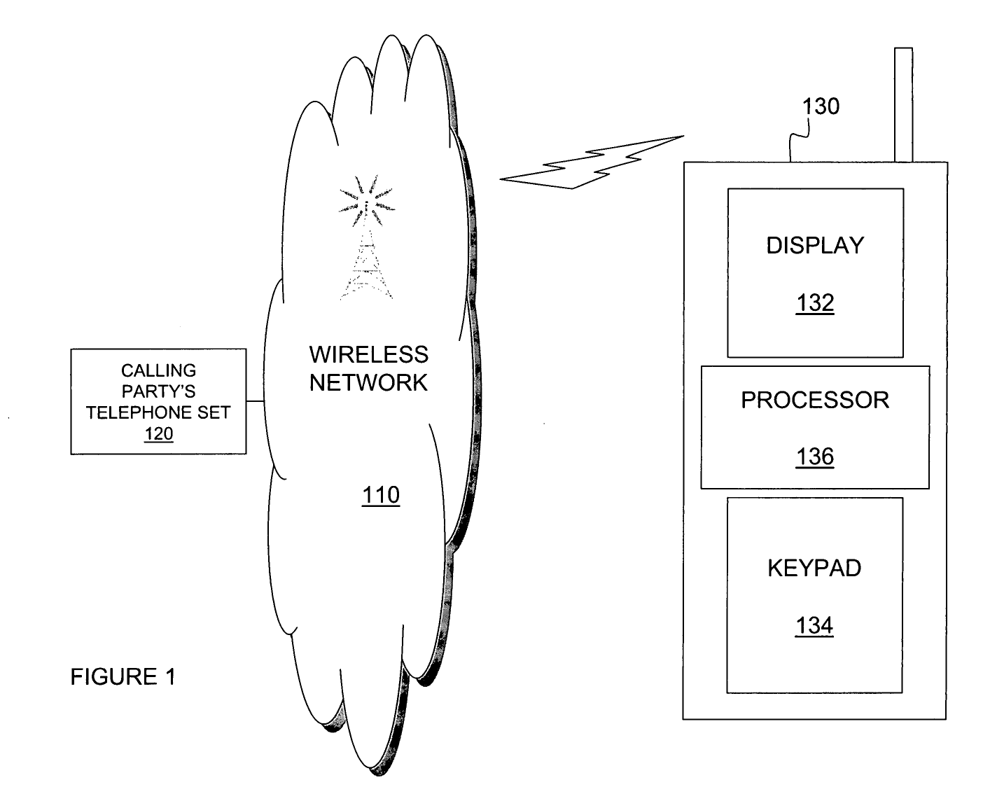

Referring initially to FIG. 1, illustrated is a schematic diagram of a wireless infrastructure containing one embodiment of a wireless communication device that includes a system for placing an inbound wireless call in context. The illustrated embodiment of the system is constructed according to the principles of the present invention.

The wireless infrastructure includes a wireless network 110. The wireless network 110 conventionally includes one or more gateways to the public switched telephone network (PSTN), one or more wireless base stations and typically supports many wireless communication devices. A calling party may place telephone calls to a selected one of the many wireless communication devices via an associated “calling party's telephone set” 120.

The term “wireless communication device” encompasses a broad array of devices. A wireless communication device could be any type of wireless telephone: time-division multiple access (TDMA), code-division multiple access (CDMA), Groupe Speciale Mobile (GSM) or all other conventional or later-developed wireless telephones. A wireless communication device could be a personal digital assistant (PDA), mobile digital assistant (MDA), portable, laptop or tablet computers or any conventional or later-developed computer equipped with a facility for communicating via a wireless communication infrastructure.

For purposes of illustration, the selected one of the wireless communication devices is illustrated as being a wireless telephone and is designated 130. The wireless communication device 130 includes a keypad 132, a display 134 (which is typically a liquid crystal display, or LCD) and a processor 136. A memory is also conventionally provided, but not shown. Though FIG. 1 illustrates the keypad 132, display 134 and processor 136 as being separate, those skilled in the art understand that they are coupled to one another (and the memory) to perform advantageous functions. The processor 136 controls the overall functions of the wireless communication device 130, allowing a user to enter commands (including telephone dialing commands) via the keypad 132 and providing the user with information via the display 134.

As mentioned above, modern wireless communication devices do much more than enable a user to initiate and receive wireless calls. The processor 136 and display 134 are sufficiently large and powerful to support a host of useful applications resident within the wireless communication device 130. More sophisticated wireless communication devices provide an operating system that underlies the applications.

For example, a calendar application may execute in the processor 136 to provide a calendar to the user. A contact management or sales automation tool application may execute in the processor 136 to keep track of and provide information on the user's customers, including their personal and business transaction data. A calculator application can cause the wireless communication device 130 to perform as a calculator. Game applications can be executed in the processor 136 to provide distraction to the user. In the illustrated embodiment, multiple of these applications may be stored in the wireless communication device 130 and called by the user or automatically as necessary.

The processor 136 further executes software, firmware or hardware that constitutes a system for placing an inbound wireless call in context. The system may make use of one or more other applications to establish the context. The architecture of one embodiment of that system will now be described.

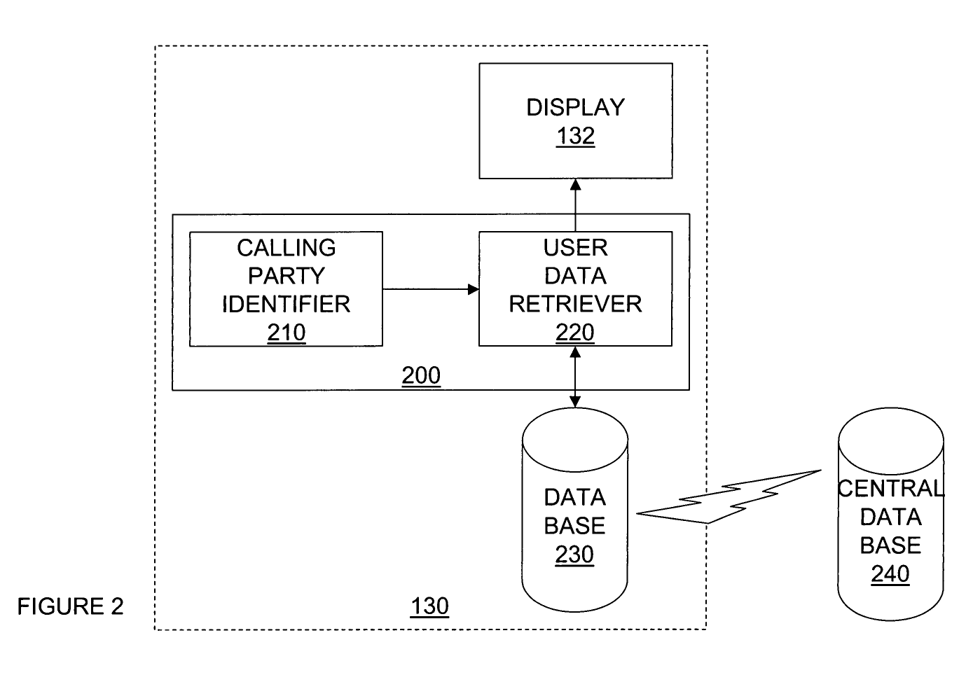

Turning now to FIG. 2, illustrated is a more detailed block diagram of one embodiment of the system, generally designated 200. The illustrated embodiment of the system 200 includes a calling party identifier 210 resident within the wireless communication device 130. In one embodiment, the calling party identifier 210 is automatically invoked by a radio interface layer (RIL) when an inbound wireless call is received. The calling party identifier 210 is configured to make an identification of a calling party associated with the inbound wireless call, which identification may be made by extracting a telephone number from the RIL.

The illustrated embodiment of the system 200 further includes a user data retriever 220 resident within the wireless communication device 130. The user data retriever 220 is configured to respond to the identification made by the calling party identifier 210 by retrieving user data associated with the calling party.

In one embodiment, the user data retriever 220 retrieves the user data from a database 230 resident within the wireless communication device 130. In an alternative embodiment, the user data retriever 220 retrieves the user data from a central database 240 that is external to the wireless communication device 130. In another alternative embodiment, the user data retriever 220 retrieves the user data from both the database 230 and the central database 240. In yet another alternative embodiment, the database 230 has recently been synchronized with the central database 240, such that the user data, though retrieved from the database 230 originated in the central database 240. In the illustrated embodiment, the database 230 is associated with an application resident within the wireless communication device 130. However, this need not be the case.

The database 230 may be one or more flat file or relational databases associated with one or more applications. Likewise, the central database 240 may be one or more flat file or relational databases associated with one or more applications and either co-located or geographically dispersed.

Irrespective of the source of the user data, the user data retriever 220 displays the user data on the display 132 of the wireless communication device 130. The user data is thereby made visible to the user, giving the user access to information to help him place the incoming wireless call in context. The system 200 may invoke one or more of the applications residing within the wireless communication device 200 to display the user data.

The user data is most advantageously, though not necessarily, displayed to the user before the inbound wireless call is completed (i.e., before the user answers the inbound wireless call). Thus, the user is not forced to stall while awaiting the display of user data.

The present invention advantageously does not require an application executing external to the wireless communication device to “push” data to the wireless communication device. Instead, the user data retriever “pulls” data by generating all requests for user data itself. If a request targets user data external to the wireless communication device, and the external user data is unavailable (perhaps because communication with the central database 240 is interrupted), the user data retriever still advantageously displays user data that it could retrieve from a database within the wireless communication device, i.e., the database 230.

Having described the structure and function of some embodiments of the system, some practical examples of its operation will now be set forth. However, those skilled in the pertinent art will understand that the present invention has many possible uses, and that a group of examples will necessarily be insufficient to encompass all possible uses.

Turning briefly back to FIG. 1, the calling party's telephone set 120 may place a telephone call via the wireless network 110 to the wireless communication device 130. Returning to FIG. 2, the calling party identifier 210 receives information from the wireless network 110, for example the automatic number identification, or ANI, associated with the calling party's telephone set 120. The calling party identifier 210 passes the ANI to the user data retriever 220. In the illustrated embodiment, the user data retriever invokes an application resident in the wireless communication device 130 and associated with the database 230, for example a calendar application, and passes the ANI to the application. The application forms a database query and queries the database 230. In the illustrated embodiment, the database 230 returns appropriate user data to the application, which the application displays to the user on the display 132. If the application is a calendar application, a calendar displaying, for example, an upcoming meeting or a most recent prior meeting with the calling party is displayed on the display 132. The user can then conveniently discuss the upcoming or most recent prior meeting with the calling party.

In another example, the calling party places a call as before, the calling party identifier 210 makes the identification as before, but the application invoked by the user data retriever is a sales automation tool application containing personal data (e.g., home telephone number, names of family members and their birthdays) and business transaction data (e.g., dates of last orders, items ordered, quantity preferences and shipping status) pertaining to the calling party. Perhaps the user has preconfigured the sales automation tool application to display the personal user data first, followed by the business transaction data. Thus, when the user answers the inbound wireless call, he can interact with the calling party on a personal basis, perhaps inquiring as to how the calling party's spouse is doing, remarking on an upcoming birthday or discussing minutiae about the calling party's last round of golf. Then, the user can seamlessly transition into a discussion of the calling party's business, complete with order status. The overall impression created on the calling party is that the user cares and is knowledgeable and in-touch.

In yet another example, the calling party places a call as before, the calling party identifier 210 makes the identification as before, the application invoked by the user data retriever is a sales automation tool application as before, but the application makes use of both the database 230 and the central database 240. For example, the personal data may be contained in the database 230, and the business transaction data may be contained in the central database 240. The application may retrieve and display the personal data from the database 230 and initiate a query via the wireless network (110 of FIG. 1) to the central database 240 such that the business transaction data arrives in time for display when the user is ready for it.

In still another example, the calling party places a call as before, the calling party identifier 210 makes the identification as before, but the user data retriever has its own database 230 and does not interact with an application. The user data retriever formulates a query based on the identification and displays any retrieved user data. The user data may simply be notes the user has previously taken regarding the calling party and stored in the database 230.

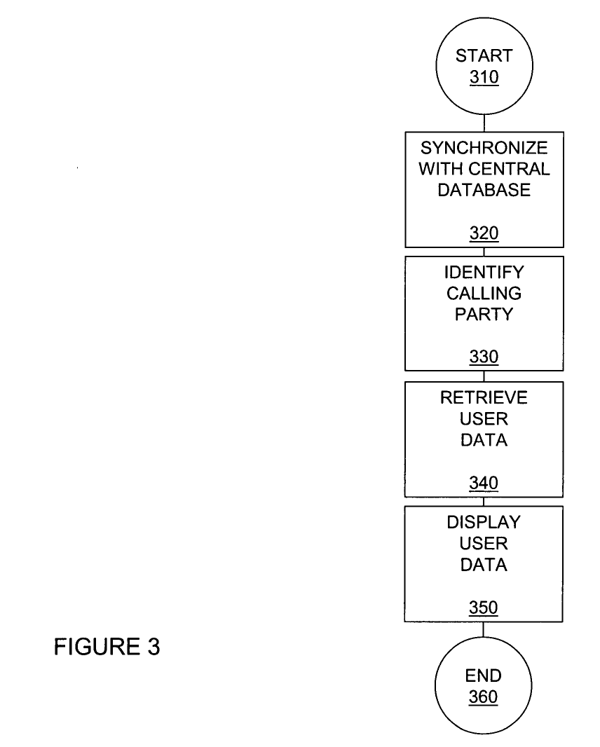

Turning now to FIG. 3, illustrated is a flow diagram of one embodiment of a method of placing an inbound wireless call in context carried out according to the principles of the present invention. The method begins in a start step 310. In an optional step 320, the database resident within the wireless communication device is synchronized with a central database external to the wireless communication device. The user data in both databases may therefore be updated. Of course, no central database or synchronization is necessary to the present invention. If performed at all, the synchronization may take place long before the inbound wireless call is received.

Upon receipt of an inbound wireless call, in a step 330, an identification is made of a calling party associated with the inbound wireless call using a calling party identifier resident within the wireless communication device. As previously described, that identification may be the ANI of the calling party's telephone set or any other identification that could serve as the basis for a database query.

Next, in a step 340, in response to the identification, user data associated with the calling party is retrieved from a database using a user data retriever resident within the wireless communication device. The retrieving may advantageously be performed before the inbound wireless call is completed (answered by the user). As previously described, the user data retriever may interact with an application, such as a calendar or sales automation tool application or even a game application, to cause the user data to be retrieved or may have its own database from which the user data is retrieved.

Then, in a step 350, the user data is displayed on the display of the wireless communication device for the user's potential benefit. The user data may be displayed in any format and in any order. The user may be able to preconfigure the format or order in which the user data is displayed. The method ends in an end step 360.

While the method disclosed herein has been described and shown with reference to particular steps performed in a particular order, those skilled in the pertinent art will understand that these steps may be combined, subdivided, or reordered to form an equivalent method without departing from the teachings of the present invention. Accordingly, unless specifically indicated herein, the order and/or the grouping of the steps are not limitations of the present invention.

Although the present invention has been described in detail, those skilled in the art should understand that they can make various changes, substitutions and alterations herein without departing from the spirit and scope of the invention in its broadest form.

1. A system for placing an inbound wireless call in context, comprising:
a calling party identifier resident within a wireless communication device and configured to make an identification of a calling party associated with said inbound wireless call; and
a user data retriever resident within said wireless communication device and configured to respond to said identification by retrieving user data associated with said calling party from a database and displaying said user data on a display of said wireless communication device.

2. The system as recited in claim 1 wherein said database is resident within said wireless communication device.

3. The system as recited in claim 1 wherein said database is synchronizable with a central database external to said wireless communication device.

4. The system as recited in claim 1 wherein said identification is a telephone number of said calling party.

5. The system as recited in claim 1 wherein said user data is selected from the group consisting of:
calendar data,
personal data, and
business transaction data.

6. The system as recited in claim 1 wherein said user data retriever retrieves said user data before said inbound wireless call is completed.

7. The system as recited in claim 1 wherein said wireless communication device is a wireless telephone.

8. A method of placing an inbound wireless call in context, comprising:
making an identification of a calling party associated with said inbound wireless call with a calling party identifier resident within a wireless communication device;
responding to said identification by retrieving user data associated with said calling party from a database with a user data retriever resident within said wireless communication device; and
displaying said user data on a display of said wireless communication device.

9. The method as recited in claim 8 wherein said database is resident within said wireless communication device.

10. The method as recited in claim 8 further comprising synchronizing said database with a central database external to said wireless communication device.

11. The method as recited in claim 8 wherein said identification is a telephone number of said calling party.

12. The method as recited in claim 8 wherein said user data is selected from the group consisting of:
calendar data,
personal data, and
business transaction data.

13. The method as recited in claim 8 wherein said retrieving is performed before said inbound wireless call is completed.

14. The method as recited in claim 8 wherein said wireless communication device is a wireless telephone.

15. A wireless communication device, comprising:
a body;
a keypad coupled to said body;
a display coupled to said body and said keypad; and
a processor located within said body, coupled to said keypad and said display and containing a system for placing an inbound wireless call in context, including:
a calling party identifier that makes an identification of a calling party associated with said inbound wireless call, and
a user data retriever that responds to said identification by retrieving user data associated with said calling party from a database and displaying said user data on said display.

16. The wireless communication device as recited in claim 15 wherein said database is located in a memory resident within said wireless communication device.

17. The wireless communication device as recited in claim 15 wherein said database is synchronizable with a central database external to said wireless communication device.

18. The wireless communication device as recited in claim 15 wherein said identification is a telephone number of said calling party.

19. The wireless communication device as recited in claim 15 wherein said user data is selected from the group consisting of:
calendar data,
personal data, and
business transaction data.

20. The wireless communication device as recited in claim 15 wherein said user data retriever retrieves said user data before said inbound wireless call is completed.

21. The wireless communication device as recited in claim 15 wherein said wireless communication device is a wireless telephone.
